(19) United States
(12) Patent Application Publication
(10) Pub. No.: US 2013/0142336 A1
(43) Pub. Date: Jun. 6, 2013

(54) METHOD OF GROUP KEY GENERATION AND MANAGEMENT FOR GENERIC OBJECT ORIENTED SUBSTANTIATION EVENTS MODEL

(71) Applicants: Steffen Fries, Baldham (DE); Maik Seewald, Nurnberg (DE)

(72) Inventors: Steffen Fries, Baldham (DE); Maik Seewald, Nurnberg (DE)

(73) Assignee: SIEMENS AKTIENGESELLSCHAFT, MUENCHEN (DE)

(21) Appl. No.: 13/697,893

(22) PCT Filed: May 14, 2010
(86) PCT No.: PCT/EP2010/002959

§ 371 Date: Dec. 28, 2012

(51) Int. Cl. H04L 9/08

(52) U.S. Cl. CPC H04L 9/0805
USPC 380/278

(57) ABSTRACT

A method and an apparatus provide dedicated group key distribution in systems employing generic object oriented substation events (GOOSE). The method includes defining a group configuration for the GOOSE system via a plurality of field devices, verifying possession by each field device in the group of an asymmetric key pair, distributing a group key individually to each field group member device by a substation controller via a secure interaction between the substation controller and the group member device, and updating the group key after the group configuration has changed.

### FIELD OF THE INVENTION

This disclosure relates generally to a method and an apparatus for group key distribution, and particularly but not exclusively relates to a method and an apparatus for dedicated group key distribution in systems employing Generic Object Oriented Substation Events (GOOSE), and a device for group key distribution in systems employing Generic Object Oriented Substation Events (GOOSE).

### BACKGROUND OF THE INVENTION

The portions dealing with security as part of document “Power systems management and associated information exchange—Data and communications security—Part 6 Security for IEC 61850 profiles”(originated in October 2006), describe the employment of digital signatures on messages to protect the integrity of the sent messages. Using digital signatures for integrity protection has been suggested, as Generic Object Oriented Substation Events (GOOSE) profile uses multicasts to distribute the messages between the different field devices. In this case the number of recipients is not necessarily known to the field device sending the message. Thus, the sender of a message may not possess a mutually shared secret with the recipients therefore providing integrity protection in an alternative way. As the creation and verification of digital signatures has a huge impact on the performance, and the GOOSE messages are performance relevant, the given security solution may not always fit. This drawback has also recently being acknowledged within the IEC TC57 groups through feasibility tests performed by the company ABB. It is note that in this context IEC TC57 refers to the group that develops and maintains International Standards for power systems control equipment and systems including EMS (Energy Management Systems), SCADA (Supervisory Control And Data Acquisition), distribution automation, teleprotection, and associated information exchange for real-time and non-real-time information, used in the planning, operation and maintenance of power systems.

Therefore, improved solutions are needed to provide integrity protection for GOOSE messages.

Various options for group key management are available and are known from the art, such as:

Group Key Management Protocol (GKMP) Architecture is an experimental specification that proposes a protocol to create grouped symmetric keys and distribute them amongst communicating peers. This protocol is virtually invisible to an operator, does not require a central key distribution site, only group members have the key, has a sender or receiver oriented operation, and can make use of multicast communications protocols.

Its disadvantages for use in connection with GOOSE applications lie in that specific certificates are needed to identify a group key controller. Moreover, GBKM does not make use of a central entity, which is available in the targeted scenario, as GBKM chooses one group member as group controller. This group controller is responsible for distributing the keys and potential key updates to the group. For the targeted solution, this would put additional burden on one of the field devices, therefore working counter to easing the processor load.

With Scalable Multicast Key Distribution the benefits of multicasting are becoming ever-more apparent, and its use much more widespread. This is evident from the growth of the Multicast Backbone (MBONE). Providing security services for multicast, such as traffic integrity, authentication, and confidentiality, is particularly problematic since it requires securely distributing a group (session) key to each of a group's receivers. Traditionally, the key distribution function has been assigned to a central network entity, or Key Distribution Centre (KDC), but this method does not scale for wide-area multicasting, where group members may be widely-distributed across the internetwork, and a wide-area group may be densely populated. Also, scalable distribution of sender-specific keys is addressed. Like the previous solution this solution expects that one group member takes over the responsibility for key generation and distribution. Moreover, it is also defined, that the group controller distributes signed group member lists, which is seen as unnecessary for the targeted use case as it puts additional burden on all members by requiring the verification of the group member list signature.

The Group Diffie-Hellman Key Exchange may not be suitable for field devices, as the effort for key calculation increases with every new member joining. Moreover, in the target scenario, a member of a group does not necessarily know the other members of a group.

The Group Secure Association Key Management Protocol (GSAKMP) provides a security framework for creating and managing cryptographic groups on a network using a centralized approach. It provides mechanisms to disseminate group policy and authenticate users, rules to perform access control decisions during group establishment and recovery, capabilities to recover from the compromise of group members, delegation of group security functions, and capabilities to destroy the group. It also generates group keys. The disadvantage of this protocol lies in that it is to heavyweight for the targeted use case. It requires the circulation of a policy token used to facilitate well-ordered group creation. It must include the group's identification, group permissions, group join policy, group controller key server identity, group management information, and digital signature of the group owner. As the target use case is rather limited regarding the application of the group key (message integrity protection), the circulation of a policy token is not necessary here.

Therefore, none of the solutions currently known in the art provide for an appropriate security solution for GOOSE messages observing the performance requirements.

### BRIEF SUMMARY OF THE INVENTION

The present invention provides a solution to the above problems by providing at least for a method for dedicated group key distribution in systems employing Generic Object Oriented Substation Events (GOOSE), comprising: defining a group configuration for the GOOSE system via its component plurality of field devices, verifying the possession by each field device in said group of an asymmetric key pair, distributing a group key individually to each field group member device by a substation controller via a secure interaction between the substation controller and the group member device, and updating the group key after the group configuration has changed.

In the above method for dedicated group key distribution, the asymmetric key pair is one of a certificate or public key, and corresponding private key, and the certificates' serial number may be used for group association. Further, the group membership may be determined by the certificate's serial number, the key material being independent from the serial number.

According to the method of the present invention, distributing a group key individually to each field group member device by a substation controller occurs via a secure interaction between the substation controller and the group member device and comprises asymmetric encryption with the public key per field device. Alternatively, distributing a group key individually to each field group member device by a substation controller via a secure interaction between the substation controller and the group member device comprises the utilization of an encrypted connection between the substation controller and the field device, initiated using the asymmetric key pair. Further, the distribution of a group key individually to each field group member device by a substation controller via a secure interaction between the substation controller and the group member device comprises negotiating a pair wise symmetric master key between each field device and the group controller, which is later used to distribute the actual group key.

A group controller in accordance with the present invention pertains to a topology comprising field devices. A field device sending a message puts it on a ring, secured with the group key. Subscribing field devices reading the message and use the group key to verify its integrity. The group controller facilitates a method for dedicated group key distribution in systems employing Generic Object Oriented Substation Events (GOOSE), comprising: defining a group configuration for the GOOSE system via its component plurality of field devices;

verifying possession by each field device in said group of an asymmetric key pair, distributing a group key individually to each field group member device by a substation controller via a secure interaction between the substation controller and the group member device, and updating the group key after the group configuration has changed.

### BRIEF DESCRIPTION OF FIGURES

The present invention together with the above and other objects and advantages may best be understood from the following detailed description of the preferred embodiments of the invention illustrated in the drawings.

FIG. 1 portrays the advantages of using IEC61850 GOOSE versus conventional hardwired systems;

FIG. 2 portrays an extended Ethertype PDU for GOOSE;

FIG. 3 illustrates GOOSE Transfer Time Definition;

FIG. 4 illustrates a ring topology of field devices exchanging GOOSE messages;

FIG. 5 portrays a GOOSE system group set up;

FIG. 6 illustrates a summary of the group key distribution mechanisms envisioned by the various embodiments of the present invention;

FIG. 7 illustrates schematically a mechanism for higher layer message protection;

FIG. 8 illustrates a GOOSE system with multiple groups;

FIG. 9 portrays a flow chart of a method of group key distribution, in accordance with an embodiment of the present invention;

FIG. 10 portrays a flow chart of a method of group key distribution, in accordance with another embodiment of the present invention;

FIG. 11 portrays a flow chart of a method of group key distribution, in accordance with a further embodiment of the present invention.

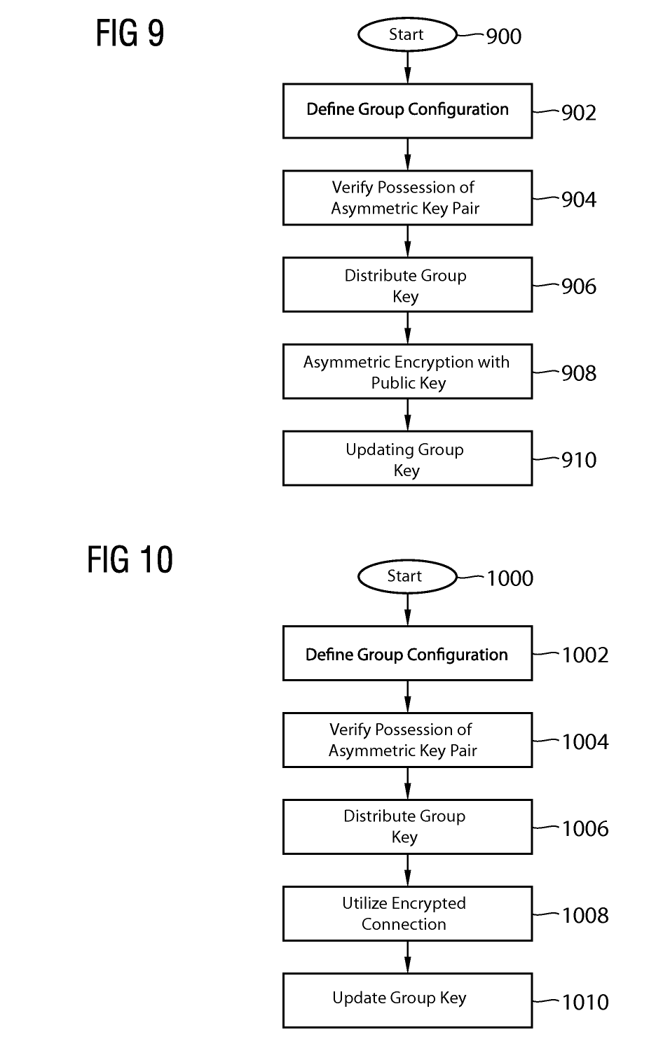

In FIGS. 9, 10, and 11 the order of description should not be construed as to imply that these operations are necessarily order-dependent.

Non-limiting and non-exhaustive embodiments of the present invention are described with reference to the above referenced figures, wherein like reference numerals refer to like parts throughout the various views unless otherwise specified. The order of description should not be construed as to imply that these operations are necessarily order-dependent.

### DETAILED DESCRIPTION OF THE INVENTION

Embodiments of a method for dedicated group key distribution in systems employing Generic Object Oriented Substation Events (GOOSE) are described herein. In the following description, numerous specific details are provided for understanding the embodiments of the present invention. One skilled in the relevant art will recognize, however, that the invention can be practiced without one or more of the specific details, or with other steps, methods, systems, components, materials, etc. In other instances, well-known structures, materials, system components, or steps of methods are not shown, or if shown are not described in detail, to avoid obscuring aspects of the invention.

Reference throughout this specification to “one embodiment” or “an embodiment” means that a particular feature, structure, step, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, steps, or characteristics may be combined in any suitable manner in one or more embodiments.

Various operations will be described as multiple discrete are steps performed in turn in a manner that is most helpful in understanding the present invention. However, the order of description should not be construed as to imply that these operations are necessarily order dependent, in particular, the order the steps are presented. Any necessary ordering is alternatively expressly mentioned or will be understood by those skilled in the art.

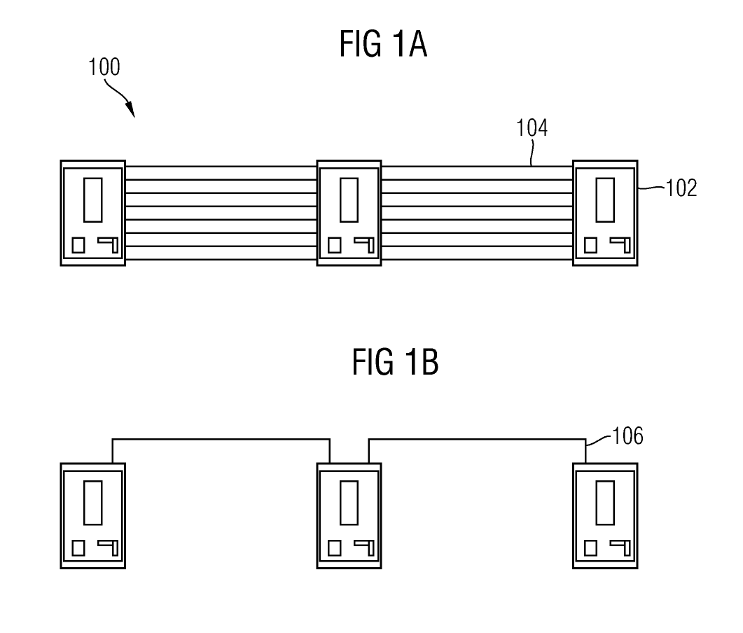

Referring now to FIG. 1, the figure portrays the advantages of using IEC61850 GOOSE versus conventional hardwired systems.

The standard ISO/IEC62351 Part 6 describes security for IEC 61850 Peer-to-Peer Profiles. It covers the profiles in IEC 61850 that are not based on TCP/IP—GOOSE, Generic Substantiation State Event (GSSE), and Sampled Message Values (SMV).

The Generic Object Oriented Substation Events (GOOSE) is a control model mechanism in which any format of data (status, value) is grouped into a data set and transmitted as substation events, such as commands, alarms, or indications. It aims to replace the conventional hardwired logic necessary for intra-IED coordination with station bus communications. Upon detecting an event, field devices use a multi-cast transmission to notify those devices that have registered (subscribed) to receive the data. GOOSE messages are re-transmitted multiple times by each field device. The reaction of each receiver depends on its configuration and functionality.

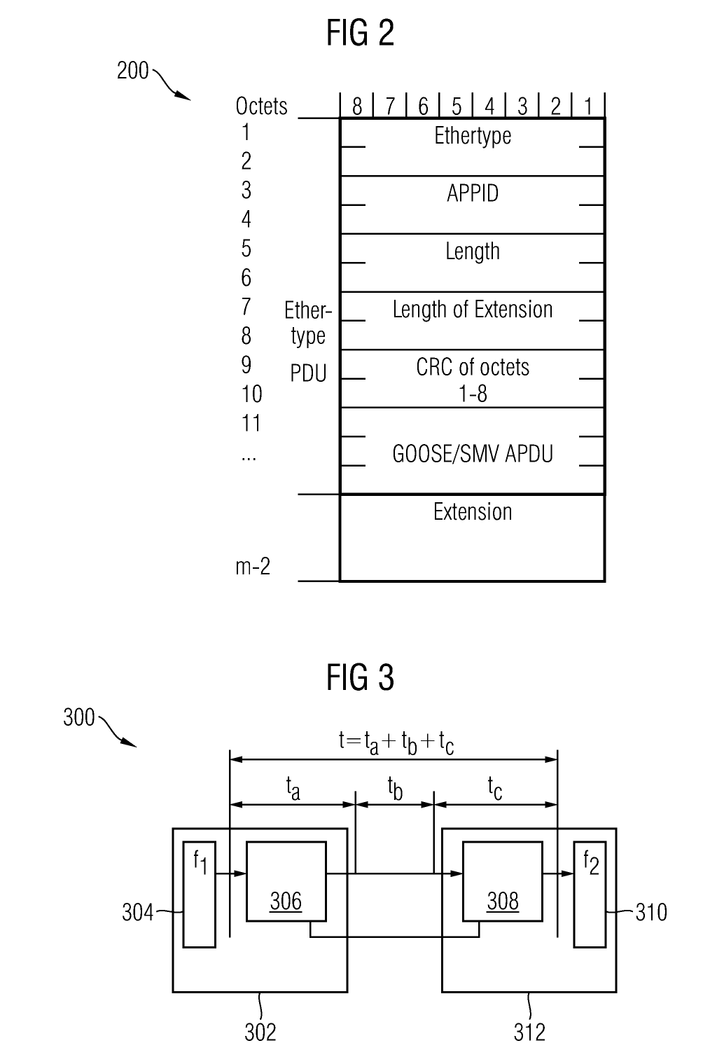

Referring now to FIG. 2, the figure portrays an extended Ethertype PDU for GOOSE in accordance with (cf. IEC 61850-7-2). In the present document with PDU is denoted a protocol data unit.

The format of the Extension octet area is:

Extension ::= {
[0] IMPLICIT SEQUENCE {
[1] IMPLICIT SEQUENCE Reserved OPTIONAL,
[2] IMPLICIT OCTETSTRING Private OPTIONAL,
[3] IMPLICIT AuthenticationValue OPTIONAL,
...
}
}

IEC 61850-5 defines message types and their performance classes. The performance classes are:
P1—typically to a distribution bay (or where low requirements can be accepted);
P2—typically to a transmission bay (or if not otherwise specified by the customer);
P3—applies typically to a top performance transmission bay;

The following table shows the different message types and their timing requirements based on the information in IEC 61850-5.

| Type | Definition | Timing Requirements |
|---|---|---|
| 1 | Fast messages contain a simple | |
| | binary code containing data, | |
| | command or simple message, | |
| | examples are: “Trip”, “Close”, | |
| | “Reclose order”, “Start”, | |
| | “Stop”, “Block”, “Unblock”, | |
| | “Trigger”, “Release”, “State | |
| | change”, etc. | |
| 1A | TRIP - most important message | P1: transfer time shall be |
| | | in the order of half a |
| | | cycle. → 10 ms |
| | | P2/3: transfer time shall be |
| | | below the order of a quarter |
| | | of a cycle. → 3 ms |
| 1B | OTHER - Important for the | P1: transfer time < 100 ms |
| | interaction of the automation | P2/3: transfer time shall be |
| | system with the process but | below the order of one |
| | have less demanding | cycle. → 20 ms |
| | requirements compared to the | |
| | trip. | |
| 2 | Medium speed messages are | Transfer time < 100 ms |
| | messages where the time at | |
| | which the message originated | |
| | is important but where the | |
| | transmission time is less | |
| | critical. | |
| 3 | Low speed messages are used | Transfer time < 500 ms |
| | for slow speed auto-control | |
| | functions, transmission of | |
| | event records, reading or | |
| | changing set-point values and | |
| | general presentation of system | |
| | data. | |

Referring now to FIG. 3, FIG. 3 illustrates GOOSE Transfer Time Definition.

The definition of transfer time, according to IEC 61850-5, is shown in FIG. 3. The transfer time includes the complete transmission of a message including necessary handling at both ends. The time counts from the moment the sender puts the data content on top of its transmission stack up to the moment the receiver extracts the data from its transmission stack. As shown in FIG. 3 transfer time of GOOSE messaging for a TRIP command shall be such that the command should arrive at the destination IED within 3 ms. For a single IED, by assuming the time for the publishing process and the subscribing process are approximately equal and if t_{b} can practically be ignored, then at least half of the defined time is needed for the IEDs to process the message (i.e. 1.5 ms for TRIP)

Application examples of GOOSE: Tripping of switchgear, Starting of disturbance recorder, Providing position status of interlocking.

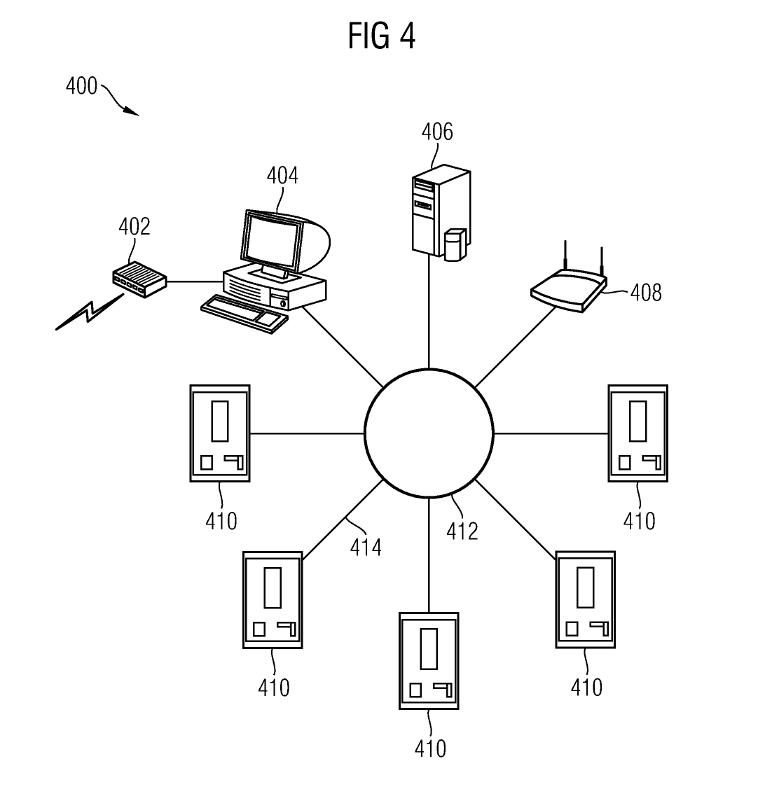

Referring now to FIG. 4, FIG. 4 illustrates a ring topology of field devices exchanging GOOSE messages.

FIG. 4 simple provides a view of field devices which are connected as a group using a ring topology. Another potential network structure to connect field devices is a tree structure. Common to both is the application of a group based key to protect the communication on either the ring or the tree. A field devices sending a message will “put” it on the ring, secured with the group key. The subscribing field devices reads the message and uses the group key to verify it's integrity.

The present invention provides a solution for integrity protection using a group based approach. The present invention provides for the insurance of integrity by using a group based key, which in some embodiments of the invention may be used in conjunction with a keyed hash (HMAC) and in alternative embodiments of the invention may be used in a hash function directly. Optionally, a further key may be derived for confidentiality protection, depending on the given security requirements.

Using a group based approach for integrity protection also changes the attack model of the communication as currently the sender of a wrong (faked or falsified) message can be identified using the digital signature contained in the message. Using group based keys the sender of a wrong message is only identifiable as member of the group, not individually. It is assumed that the members of the group are equally trusted and that therefore a group based approach is sufficiently secure.

As the subscription process is a local matter, there is no need for a default group controller for the communication. Thus, for security the establishment of a group based key may be achieved either with or without a dedicated group master. For the purposes of one embodiment of the present invention, it is assumed that the group key is establish using a dedicated group controller, as decentralized schemes require more effort in the initial establishment phase which should be reduced here. Alternatively, it is envisioned in another embodiment of the present invention that a decentralized scheme is used.

Moreover, an autonomous group key establishment without interaction with a substation controller or an engineering tool is currently not in the field device deployment process. Engineering is typically performed using a SCD (System Configuration Description) File. For the context of the description of an embodiment of the invention it is assumed that each field device already possesses an asymmetric key pair (certificate or public key and corresponding private key). These keys have also been made available on the field devices for remote management and engineering operations.

The group key distribution may be made in accordance with the present invention, either manually or automatically. As it will be described further in the present document, depending on the key distribution mode—manual or automatic—a group key distribution protocol may be used. The group controller in this case may be the substation controller. If manual key distribution is targeted, it can be performed using the engineering process.

Irrespective if the group key is envisioned to be distributed manually or automatically, at first it needs to be defined how a group is build to issue a dedicated key to that group. As the subscription process is a local matter of the connected devices one criterion for distinction may be the application identifier AAPID, which is part of the Ethertype in the ISO/IEC 8802-3 frame format. For GOOSE message there exists a reserved range between 0×0000 to 0×3FFF. This would lead to a maximum of 16384 possible sub groups, which may result in a complex configuration. In certain scenarios it may be sufficient to use only one group key, e.g., for a geographical close group within a substation. This would ease the configuration as only a single group key must be administered and decreases also the error-proneness in case of manual group key configuration.

For the embodiment of the present invention that focuses on automatic key distribution, it is of note that said automatic key distribution may be performed based on a Group Secure Association Key Management Protocol GSAKMP such as RFC4535 stand alone, or as enhancement to an existing protocol message exchange. In the following, the embodiment of the present invention that assumes that the key distribution is accomplished as part of an existing protocol will be discussed.

As an alternative distribution mode to a separate protocol it is on note the application of IEC 62351 Part 4 describing the security for Multimedia Messaging Service (MMS), as asymmetric cryptography is already applied to realize component authentication.

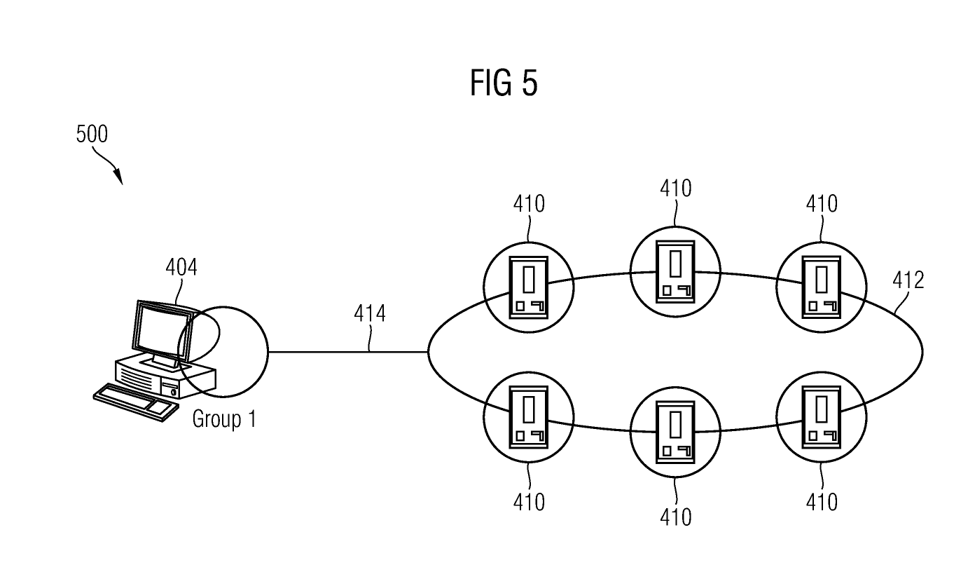

Referring now to the illustration of FIG. 5, that illustrates a group set up, in FIG. 5 is illustrated a group 500 comprising a for example a station computer 404 that may be implemented as a station controller. The station controller 404 may be the engineering tool that embodies a group controller and is responsible in the group-based key management for the initial distribution of keys and for the key update after join and leave of any of the plurality of intelligent electronic devices 410 part of group 412. A link 414, that a person skilled in the art will now to implement via a bus or wirelessly, facilitates the communication between the group controller 404 and the group of devices 410.

It is essential that the group controller knows, by some specific means, which devices 410 belong to a dedicated group 412. Since the assumption is that each field device already possesses an asymmetric key pair, this may be done best based on device's specific asymmetric keys (certificate and corresponding private key). For example, the certificates' serial number may be used for a group association. Based on these keys, the group controller 404 or alternatively a substation controller, may distribute the group key(s) in a secure way to the field devices 410. This is typically done during the engineering phase or when a substation is initially setup.

In the present invention a plurality of different options are envisioned for distributing the group key based on the available asymmetric credentials already possessed by the field devices. They are:
Asymmetric encryption with the public key per field device;
Utilization of an encrypted connection between group controller (e.g., substation controller) and field device, initiated using the asymmetric key pair;
The negotiation of a pair wise symmetric master key between each field device and the group controller, which is later used to distribute the actual group key.

Therefore, to summarize, in accordance with the present invention, a method for dedicated group key distribution in systems employing Generic Object Oriented Substation Events (GOOSE), comprises at least the steps of defining a group configuration for the GOOSE system via its component plurality of field devices, verifying the possession by each field device in the group of an asymmetric key pair, distributing a group key individually to each field group member device by a substation controller via a secure interaction between the substation controller and the group member device, and updating the group key after the group configuration has changed.

The asymmetric key pair is one of a certificate or public key, and corresponding private key. The serial number, which is part of the certificate structure, may be used for a group association.

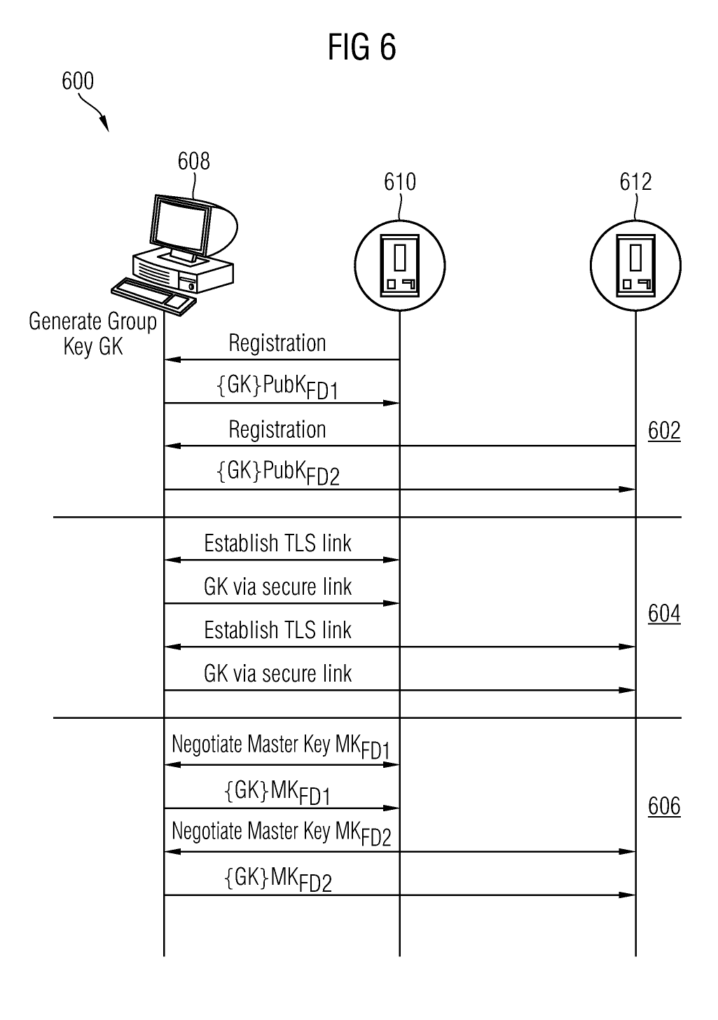

Referring now to the illustration of FIG. 6, FIG. 6 illustrates a summary of the group key distribution mechanisms envisioned by the various embodiments of the present invention.

As it may be observed in FIG. 6, a group controller 606 generates a group key denote with GK in FIG. 6. Said group key is intended to be distributed to a group of field devices of which field device 610 and field device 612 are illustrated in FIG. 6. The fact that the exemplary group of

FIG. 6 comprises only two field devices is not intended to be a limiting feature more so since the GOOSE systems are envisioned to comprise a plurality of field devices that is larger than two field devices.

In group key distribution sequence 602, that illustrates the symmetric encryption with the public key per field device, in a first step the field device 610 registers with the group controller using a the asymmetric key in its possession. Upon successful registration (and authentication) with the group controller, the group controller returns to the field device 610 the group key. The same sequence of steps occurs during an interaction between the field device 612 and the group controller 612 and continues till all the members of the GOOSE group have received their group keys. Said interaction between the group member field devices and the group controller must not be sequential, various field devices being able to retrieve their group keys from the group controller at the same time, depending upon the functionality of the group controller. Such a distribution based on asymmetric keys is for example part of an existing protocol, such as IEC 61850 messages.

In group distribution sequence 604, that illustrates the utilization of an encrypted connection between group controller 608 and the field device 610 and 612, initiated using the asymmetric key pair, a transport layer security (TLS) link is established between the field device and the group controller based on the secure key already possessed by the field device. The group controller 608 returns the generated group key via a secure link to the group field device. Such a group key distribution sequence 604 is a distribution based on an existing secure link part of an existing protocol, such as IEC 61850 messages.

In group key distribution sequence 606, where the negotiation of a pair wise symmetric master key between each field device and the group controller is done protected with the asymmetric keys of the field devices. This pair wise master key is later used to distribute the actual group key. The field devices 610 and 612 receive the group key secured with the corresponding master key MK 1 and MK2 from the group controller.

The group keys are static for a limited time. The group key may be updated after this limited time, which is a configurable time period. The group key may also be updated if new field devices join the group or if old devices are removed from the group. From a security point of view this is necessary to avoid that a late joiner can read information exchanged before the field device joined the group and to also avoid that a field device leaving the group can read afterwards the information exchanged.

For key updates the group controller may repeat the initial steps for group key distribution based on the existing key material. In case a symmetric master key has been negotiated in the initial setup, the group controller can use this master key to distribute the new group key avoiding asymmetric operations. This can be seen as a performance optimized approach.

As mentioned above, the group key distribution may as well be accomplished manually via existing engineering tools. The existing engineering tools can connect securely to the field device to provide configuration parameter(s). The manually provided group key(s) are a further configuration parameter. Since the group key distribution is done manually, an automatic key update is also not performed. This will result in higher effort for engineering in case of joining and leaving the group.

The above referenced aspects and the above described specific embodiments of the present invention find a plurality of applications. Two of the possible applications will be described in detail in the following portions of the present document.

The distributed group key can be applied to provide different security services. Based on the currently targeted and described solution in the International Electrotechnical Commission IEC 62351—Power systems management and associated information exchange—Data and communications security, Part 6, the distributed group key can be used to provide message integrity. The present proposal does not consider message confidentiality but may be enhanced to provide the appropriate security service. Message integrity for the group communication can be provided by computing a Message Authentication Code (MAC), which utilizes the group key. A solution approach is a keyed hash function (HMAC) in which the group key is applied as key.

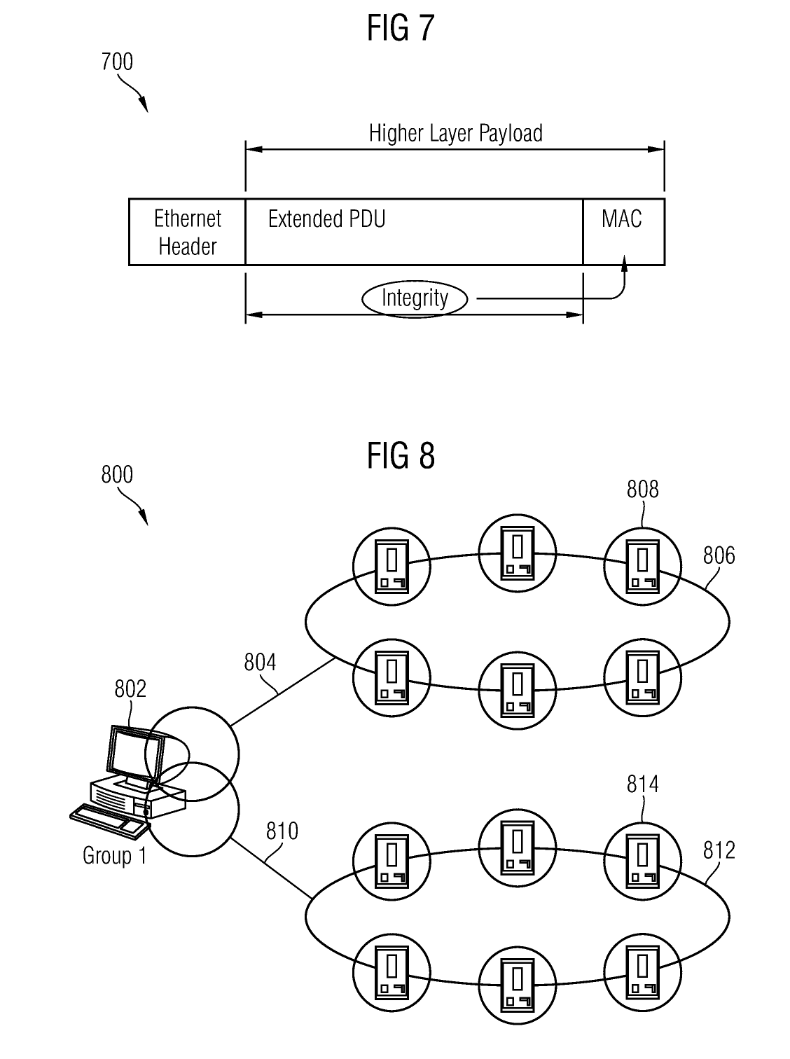

Referring now to FIG. 7, FIG. 7 illustrates schematically a mechanism for higher layer message protection.

In accordance with FIG. 7 the integrity check value may be computed over an extended PDU with the exception of the Authentication Value and sent as part of the Authentication Value. The authentication value is defined for example as shown in IEC 62351 Part 6 section 7.2.

Using the Authentication Value as it is currently defined provides a straight forward approach to carry out the integrity protection value based on a group key instead of the currently defined digital signature value. If the Application Identifier APPID has been used to distinguish between different groups, it is also contained in the extended protocol data unit and provides therefore the information, which group key is to be used. Moreover, as part of the extended protocol data unit, this value is also integrity protected.

Nevertheless, it is also proposed to enhance the Authentication Value structure to be able to provide additional information to the applied key or to the algorithm used for integrity protection. This requires the specification of a mandatory algorithm as part of the standard, but leaves it up to the vendor to provide alternative algorithms as well. Moreover, this approach also saves the original approach using digital signatures. An exemplary Abstract Syntax Notation ASN.1 enhancement could be the following:

Params ::= SEQUENCE {

| | |
|---|---|
| ranInt | INTEGER OPTIONAL, -- some integer |
| | value |
| iv8 | IV8 OPTIONAL, -- 8 octet initialization |
| | vector |
| ... | |
| } | |

AuthenticationValue ::= SEQUENCE {

| | |
|---|---|
| algorithmOID | OBJECT IDENTIFIER, |
| paramS | Params, -- any “runtime” parameters |
| aValue | BIT STRING |

These enhancements offer transport of the actual integrity check value information as well as algorithm information, describing which algorithm was used to calculate the integrity check value. It is important to assure that no fields are part of the calculation, which may be altered by regular components on the communication path. The group key may also be used in the future to derive further keys to encrypt the messages to avoid eavesdropping of the content while in transport (necessity depends on the threat model).

The approach using group based keys in conjunction with keyed hashing for integrity protection of GOOSE message exchanges between field devices has the advantages that less computational effort are required for the single messages and thus less performance requirements are present to the underlying hardware. Further, the solution allows flexible provisioning of integrity protection mechanisms, and even allows keeping the currently defined option, allows to maintain the flexibility of publish and subscribe mechanism, and exhibits efficient group key update using automated key management.

In accordance with the Publisher-Subscriber Model a GOOSE message is not addressed by the sender to a particular receiving relay. Rather, it is sent as a multicast message with identification of the sender, and with the identification of the specific message so that its point contents can be determined by listeners. Every other relay and IED on the LAN can see the message, and decide on its own whether it needs to look at the contents of this message.

The transmitting IED is called the publisher, and any other relay or IED that is configured to look for and use this particular message is called a subscriber. IEC 61850 provides for convenient setup of publisher-subscriber relationships based on self-description by potential publishers, and automatic configuration tools. The determination about group association is done based on the configuration in the system configuration description (SCD) file.

GOOSE messaging is an unconfirmed service. This means that the publisher has no mechanism for finding out if all the subscribers got the latest information—in fact, it does not even know who all the subscribers are. There is no mechanism, and really no time, for a long list of subscribers to come back and confirm that they did not receive the message, nor can they request a retransmission. Because of this, the publisher must keep on filling the LAN with updated GOOSE messages, and the burden of catching them falls to the individual subscribers.

The approach using group based keys for integrity protection of GOOSE message exchanges between field devices exhibits also that in case of automatic key management the group controller functionality must be available, but can be put onto the substation controller. Further, in case of manual key management group key updates are to be done in manual mode as well posing additional administrative overhead for the engineering. Further yet, in case of security breaches, they relate to the group not to an individual field device, application of group key instead of device specific key.

The further application described in detail in the following portions of the present document refers to group key distribution management for single or multiple groups.

Referring again to the illustration of FIG. 5, it is noted that for the single group illustrated in the figure, a group controller 404 may build a single group. In this use case all messages are protected using a single group key.

Referring now to the illustration of FIG. 8, that illustrates a GOOSE system with multiple groups, the group controller 802 may build multiple groups 806 and 812, each comprising a plurality of field devices 808 and 814. Said multiple groups may be built even between the same physical devices. This flexible configuration enables the options to have sub-groups of dedicated devices which can be build based upon geographic location, priority of operation, or other parameters and to have sub-groups of messages, for example, dedicated message types belonging to one group. This enables for instance a clustering of messages of different priorities into different groups, which are identified by a group identifier. If a subscriber receives a message it may then use the key associated with the group identifier.

FIG. 9 portrays a flow chart of a method of group key distribution, in accordance with an embodiment of the present invention.

As illustrated in FIG. 9, method 900 for dedicated group key distribution in systems employing Generic Object Oriented Substation Events (GOOSE), comprises the step of defining a group configuration for the GOOSE system 902 via its component plurality of field devices, the step of verifying possession 904 by each field device in said group of an asymmetric key pair, the step of distributing a group key individually to each field group member device 906 by a substation controller via a secure interaction between the substation controller and the group member device, and the step of updating the group key 910 after the group configuration has changed. The step of distributing a group key individually to each field group member device by a substation controller via a secure interaction between the substation controller and the group member device comprises the step of asymmetric encryption 908 with the public key per field device.

FIG. 10 portrays a flow chart of a method of group key distribution, in accordance with another embodiment of the present invention;

As illustrated in FIG. 10, method 1000 for dedicated group key distribution in systems employing Generic Object Oriented Substation Events (GOOSE), comprises the step of defining a group configuration for the GOOSE system 1002 via its component plurality of field devices, the step of verifying possession 1004 by each field device in said group of an asymmetric key pair, the step of distributing a group key individually to each field group member device 1006 by a substation controller via a secure interaction between the substation controller and the group member device, and the step of updating the group key 1010 after the group configuration has changed. The step of distributing a group key individually to each field group member device by a substation controller via a secure interaction between the substation controller and the group member device comprises the step of utilization of an encrypted connection 1008 between the substation controller and the field device, initiated using the asymmetric key pair.

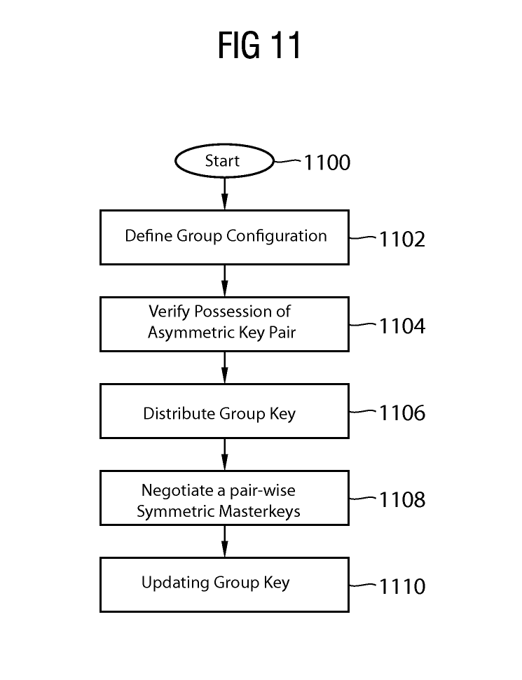

FIG. 11 portrays a flow chart of a method of group key distribution, in accordance with a further embodiment of the present invention.

As illustrated in FIG. 11, method 1100 for dedicated group key distribution in systems employing Generic Object Oriented Substation Events (GOOSE), comprises the step of defining a group configuration for the GOOSE system 1102 via its component plurality of field devices, the step of verifying possession 1104 by each field device in said group of an asymmetric key pair, the step of distributing a group key individually to each field group member device 1106 by a substation controller via a secure interaction between the substation controller and the group member device, and the step of updating the group key 1010 after the group configuration has changed. The step of distributing a group key individually to each field group member device by a substation controller via a secure interaction between the substation controller and the group member device comprises the step of negotiating 1008 a pair-wise symmetric master keys between each field device and the group controller, which is later used to distribute the actual group key.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1-7. (canceled)

8. A method for dedicated group key distribution in systems employing generic object oriented substation events (GOOSE), which comprises the steps of:
defining a group configuration for a GOOSE system having a plurality of field devices;
verifying possession by each of the field devices in the group configuration of an asymmetric key pair;
distributing a group key individually to each field group member device by a substation controller via a secure interaction between the substation controller and the field group member device; and
updating the group key after the group configuration has changed or after a limited period of time.

9. The method for dedicated group key distribution according to claim 8, which further comprises forming the asymmetric key pair from one of a certificate or a public key and a corresponding private key.

10. The method for dedicated group key distribution according to claim 9, which further comprises using a serial number of the certificate to determine group membership.

11. The method for dedicated group key distribution according to claim 9, wherein distributing the group key individually to each of said field group member device by the substation controller via the secure interaction between the substation controller and the group member device includes an asymmetric encryption with the public key per field device.

12. The method for dedicated group key distribution according to claim 8, wherein distributing the group key individually to each said field group member device by the substation controller via the secure interaction between the substation controller and the group member device includes a utilization of an encrypted connection between the substation controller and the field device, initiated using the asymmetric key pair.

13. The method for dedicated group key distribution according to claim 8, wherein the step of distributing the group key individually to each said field group member device by the substation controller via the secure interaction between the substation controller and the group member device further includes:
negotiating at least one pair-wise symmetric master key between each said field device and the group controller, which is later used to distribute an actual group key.

14. A group controller pertaining to a topology containing field devices for sending a message onto a ring or a tree structure, secured with a group key, and subscribing field devices reading the message using the group key to verify a message integrity, the group controller facilitating a method for dedicated group key distribution in systems employing generic object oriented substation events (GOOSE), the group controller programmed to:
define a group configuration for a GOOSE system having a plurality of the field devices;
verify possession by each said field device in the group configuration of an asymmetric key pair;
distribute a group key individually to each field group member device by a substation controller via a secure interaction between the substation controller and the group member device; and
update the group key after the group configuration has changed.
